(19) United States
(12) Patent Application Publication
(10) Pub. No.: US 2015/0292713 A1
(43) Pub. Date: Oct. 15, 2015

(54) Glass Lens LED Luminaire for Underwater Use

(71) Applicants: Mark Branson, Hinckley (GB); Henning von Spreckelsen, Cranleigh (GB); Paul Freedman, London (GB)

(72) Inventors: Mark Branson, Hinckley (GB); Henning von Spreckelsen, Cranleigh (GB); Paul Freedman, London (GB)

(21) Appl. No.: 14/680,215

(22) Filed: Apr. 7, 2015

(30) Foreign Application Priority Data
Apr. 11, 2014 (GB) 1406593.2

(51) Int. Cl. F21V 13/04; F21V 23/00; F21V 31/00

(52) U.S. Cl. CPC F21V 13/04; F21V 31/005; F21V 23/005; F21Y 2101/02

(57) ABSTRACT

A lighting unit (2) comprises a base member (8) supporting a plurality of LEDs (4) on a PCB (6), a specular reflector (10) surrounding the LEDs in order to direct low angle rays out of the unit. A moulded glass Fresnel lens plate (20) is mounted across the reflector above the PCB, and a clamping member (30) seals the base member and the lens plate in order to create a water tight unit.

### CROSS REFERENCE TO RELATED APPLICATION

This application claims priority to and the benefit of the filing date of Great Britain Patent Application No. 1406593.2, filed on Apr. 11, 2014, the entire disclosure of which is incorporated by reference herein.

### TECHNICAL FIELD

The present invention relates to lighting units or luminaires for marine or other underwater use using LEDs as the light source or engine.

### BACKGROUND ART

Sealed light-emitting diode (LED) lighting units for mounting to the exterior hull of a yacht in order to project a beam of light into the surrounding sea are known and described for example in U.S. Patent Application Publication No. 2007/139913 A by N. Savage.

When LEDs are used to create a light engine, a heat sink needs to be provided in order to dissipate heat generated. Savage proposed utilising the cooling effect of direct contact between the water in the housing to dissipate the heat generated by the LEDs in use.

LED light engines also require collimators in order to direct the light from an LED array into a single beam of light. The design of the collimator must take into account that one face of the optical structure will be submerged in liquid rather than air, reducing the effect of refraction at this boundary. Typically each individual LED is provided with its own collimator in existing designs of marine lights.

The lighting unit must also be capable of sealing to prevent ingress of water. Even small amounts of water ingress create condensation problems inside the unit and affect its optical properties.

The lighting unit must also be capable of withstanding the pressure down to around 100 m to be suitable for marine use. Moreover, it must be capable of tolerating impacts.

It is known that a moulded glass Fresnel lens can be used with an LED light engine to produce a high-powered beam suitable for use as a compact spot lamp for use in film production. In this application space is not at a premium and barn doors can be used for beam shaping. However, such an optical solution has not been employed in underwater lights due to the technical problems of size, structural integrity, sealing and heat dissipation.

### SUMMARY OF INVENTION

In order to solve these problems it is proposed to provide a lighting unit comprising a base member carrying a PCB supporting a plurality of LEDs, a specular reflector surrounding the LEDs in order to direct low angle rays out of the unit, a moulded Fresnel lens plate mounted across the reflector above the PCB, and a clamping member to seal to the base member and the lens plate in order to create a water tight unit.

The combination of a moulded Fresnel lens with a specular reflector within a watertight sealed body containing a LED light engine produces a converging crossover beam from the low angle rays emitted by the LEDs that combines with a collimated beam produced from the Fresnel lens. In this way, a compact, low profile unit can be produced which produces a high quality beam.

Preferably the lens plate has a central Fresnel structure moulded into its internal surface surrounded by an annular clear region through which a secondary beam of low angle rays emerges from the unit.

In order to provide the required structural integrity and resistance to depth pressure and impacts, the lens plate can be made of glass.

### BRIEF DESCRIPTION OF DRAWINGS

In order that the invention may be well understood, an embodiment thereof will now be described by way of example only, with reference to the accompanying diagrammatic drawings, in which:

FIG. 1 shows a plan view of a lighting unit in accordance with the invention;

FIG. 2 is a vertical section on the line C-C in FIG. 1;

FIG. 3 is a detail view of a central region of FIG. 2;

FIGS. 4 and 5 shows plan views illustrating alternative arrangements of LEDs.

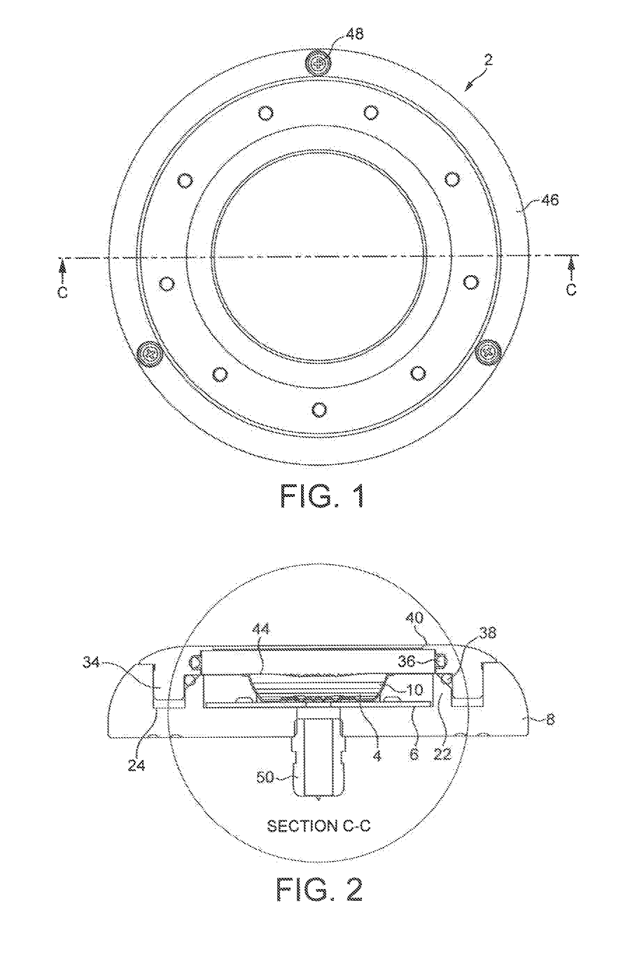

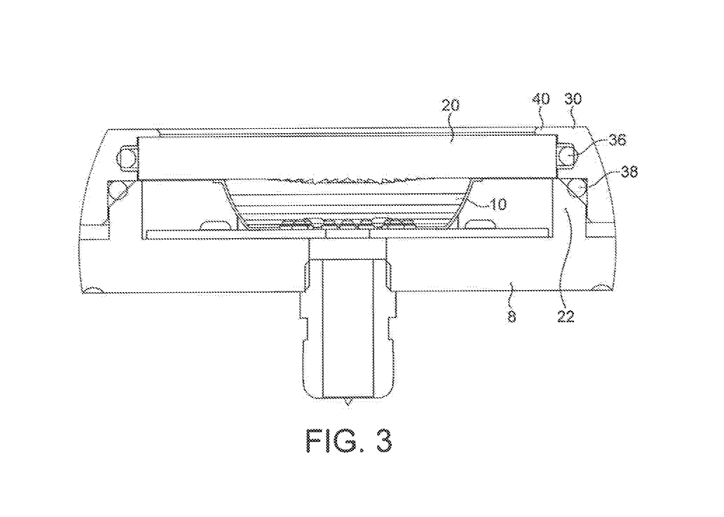

### DESCRIPTION OF EMBODIMENTS

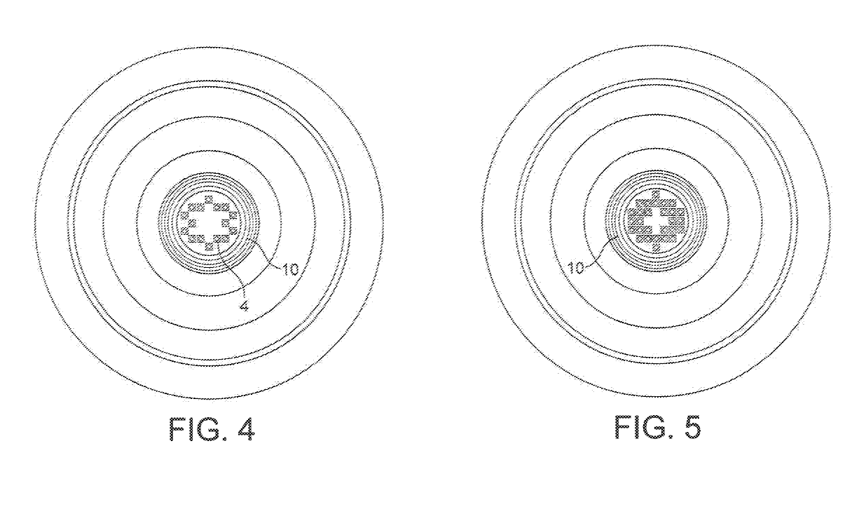

A lighting unit 2 for marine or other underwater use has an array of LEDs 4 mounted on a printed circuit board 6. The unit is made up of a base member 8 which can be a metal casting or polymer moulding. The base member 8 supports the printed circuit board 6 on which the LEDs 4 are mounted. The LEDs are arranged in an array as shown in FIG. 4 or 5.

A specular reflector 10 surrounds the array of LEDs. The unit is closed by a moulded glass Fresnel lens plate 20 which seats on top of the reflector 10 and has edges that rest on an annular projection 22 of the base member. The projection 22 forms an inner wall of an annular slot 24 surrounding the base member 8.

A clamping member 30 completes the unit and provides a mechanism for sealing the assembly into a watertight package. The clamping member is an annular ring 32 with a depending leg 34 that slides into the slot 24 in the base member 8. An O ring seal 36 is provided between the ring 32 and the edge of the lens plate 20. An edge 40 of the ring provides a small, thin overlap of material at the peripheral suffice of the lens plate 20 to seal against that surface. Another O ring seal 38 seats between the projection 22 and the leg 34 to prevent water penetrating into the internal cavity housing the LEDs and reflector.

The lens plate 20 is moulded glass. It has a plane outer surface facing the water and a shaped internal surface to define a Fresnel lens structure 42 in a central region. The Fresnel lens is designed so that it creates a collimated primary beam from light rays striking it from the array of LEDs, whether directly or after reflection from the reflector 10. The use of glass allows the lens plate to function both as a beam shaper (in conjunction with the reflector 10) and to provide structural integrity and rigidity so that the unit can be sealed and offer the required depth pressure and impact resistance.

The reflector 10 has an internal mirror finished profile which is shaped to perform two functions. It directs the low angle rays emitted from the LEDs out of the unit through a plain edge region 44 of the lens plate, and also reflects higher angle rays back toward the Fresnel lens structure 42. In this way two converging beams are created that cross over a few centimetres from the face of the lens plate and effectively merge to form a single beam from the front face of the unit.

An annular region of the lens plate 20 at the front of the unit beyond the edge of the reflector 10 may be frosted while the central region inside the reflector is clear. The lens plate is preferably moulded from glass.

The base member 8 can have a peripheral flange 46 to receive screws 48 to provide for flush mounting to a wall, that may be the hull of a ship or an undersea structure. The bottom of the base member is preferably in thermal contact with the adjacent wall if it is conductive. The base member serves to provide a thermal path for internally generated waste heat to be conducted to the wall surface to which the unit is mounted.

The base member 8 has a central opening into which a sleeve 50 is fitted in order to provide for the passage of electrical connections to the circuit board 6.

The LEDs 4 are arranged on the PCB in a pattern that is determined by their interaction with the reflector and the number required. Suitable patterns of the LED array are shown in FIGS. 4 and 5.

1. A lighting unit comprising a base member carrying a printed circuit board (PCB) supporting a plurality of LEDs, a specular reflector surrounding the LEDs in order to direct low angle rays out of the lighting unit, a moulded Fresnel lens plate mounted across the reflector above the PCB, and a clamping member to seal to the base member and the moulded Fresnel lens plate in order to create a water tight unit.

2. A lighting unit as claimed in claim 1, wherein the moulded Fresnel lens plate has a central Fresnel structure moulded into its internal surface surrounded by an annular clear region through which a secondary beam of low angle rays emerges from the lighting unit.

3. A lighting unit as claimed in claim 1, wherein the moulded Fresnel lens plate is a piece of moulded glass.

4. A lighting unit as claimed in claim 2, wherein the moulded Fresnel lens plate is a piece of moulded glass.
